(19) United States
(12) Patent Application Publication
(10) Pub. No.: US 2006/0167736 A1
(43) Pub. Date: Jul. 27, 2006

(54) Schedule chart for project management

(76) Inventor: Paul F. Weiss, Rockport, MA (US)

Correspondence Address: RADER FISHMAN & GRAUER PLLC, LION BUILDING, 1233 20TH STREET N.W., SUITE 501, WASHINGTON, DC, 20036, US

(21) Appl. No.: 10/529,853

(22) PCT Filed: Sep. 30, 2003
(86) PCT No.: PCT/US03/30747

§ 371 Date: Nov. 23, 2005

Related U.S. Application Data
(60) Provisional application No. 60/414,646, filed on Oct. 1, 2002.

(51) Int. Cl. G06F 9/46

(52) U.S. Cl. 705/9

(57) ABSTRACT

This invention relates to a method of portraying project schedule history in graphical form which facilitates a rapid assessment of the success of a project and its leaders from the standpoint of performance against schedule. More specifically, this invention relates to an “Estimated Time to Completion” chart that is plotted against “Date” in a two dimensional chart, and points on the chart are created at periodic checkpoints for the duration of the project. When the points are connected, a line is created which slants toward the “Date” axis and intersects that axis at the actual completion date. Partially-completed charts are useful at the periodic checkpoints for graphically illustrating how well the project team is holding to the schedule. Completed charts are useful in evaluating performance of team leaders and for creating incentives for timely performance of projects. Methods of adapting the charts to changes in project scope are included in this invention. The invention also relates to a method having steps for making the chart, both manually and by computer.

### INTRODUCTION

This application is based on and claims the benefit in the United States of U.S. Provisional Application No. 60/44,646, entitled SCHEDULE CHART FOR PROJECT MANAGEMENT, filed Oct. 1, 2002, the entire disclosure of which is hereby incorporated by reference.

### BACKGROUND OF THE INVENTION

1. Field of the Invention

The present invention generally relates to devices and methods for project management, and particularly relates to a device and method for generating schedule charts that present an overview of how well projects and tasks have remained on schedule. More particularly, this invention relates to printed material on a suitable substrate in the form of a schedule chart, and to a method of making such charts, and to a method of using such chart by projection by electronic means, as well as to a computer-driven method of making such charts.

2. Description of Prior Art

Graphical management tools are well known and include nomographs, graphical plots, and other charts specifically portraying an event, such as temperature, plotted against a parameter on the ordinate and abscissa of a graph. An overall purpose of such tools is to indicate quickly a situation that occurs at some particular time.

With the advent of more sophisticated management techniques, bar charts, pie charts, and other types of charts have been provided to show the amount of time to perform a task that is part of a project. As examples of projects having need for such charts, Gantt charts and PERT (Project Evaluation Research Techniques) have become available, often tied to an MRP (Management Resource Planning) enterprise computer program to monitor inventory of raw materials, machinery, manpower, and inventory of finished goods.

One example of a project schedule chart for a construction project is found in U.S. Pat. No. 5,709,410 to Reeves in which a plurality of discrete development tasks are listed in a precedential order with a calendar overlay. Another example, relating to a computer controlled system is found in U.S. Pat. No. 5,420,978 to Tozawa that enables user to interactively modify a schedule display in sequence in building or upon completion of a scheduling system.

A shortcoming of charts of the types described is their complexity in creating the chart and in using the chart for immediate conveyance of pertinent status information. Accordingly, it is an overall object of this invention to provide such a chart, and a method for its making that are simple, and that immediately convey information on the status of a project.

3. Summary of the Invention

The invention comprises a method of displaying performance against a schedule, wherein the estimated time to completion is plotted against time in a two-dimensional chart (“CHART”). Time-to-completion is estimated periodically through the duration of project execution, and each such estimate creates a new point on the CHART. Points on the CHART are connected by a line which advances toward the time axis until it intersects the time axis upon project completion.

### 4. ONE SPECIFIC EMBODIMENT (EXAMPLE—MANUAL METHOD)

In preparation for the use of a CHART in a specific application, certain steps which are not a part of this invention are appropriate, as they would be for any project management tool. For example, it is usually desirable to segment a project into tasks which are defined in sufficient detail that it can be determined unambiguously when the tasks have been completed. Tasks are then customarily segmented into groups that must (or should) be completed at the same time (for the purpose of this invention, such a group is referred to as a “SET”).

While agreement with project and task leaders on scheduled start and completion dates for each SET is customary in any project, an additional preparatory step is desirable for use of a CHART-to secure agreement with project and task leaders that the completion date for each SET will be re-estimated at nominally regular intervals (“CHECKPOINTS”) during the execution of the project. Such checkpoints may or may not be customary, depending upon the organization and the management responsible for the project. Once agreement on checkpoint estimations of completion dates has been secured, a CHART incorporating the innovations of this invention can be generated using the following steps a) through e):
a) Establish for each SET a table containing columns for checkpoint number (n), ordered pairs

of dates (CPD(n),ECD(n)) where “CPD(n)” is the nth checkpoint date, and “ECD(n)” is the

estimated completion date for the SET as of the nth checkpoint date.

A fourth column contains a calculated entity—Time To Completion TTC(n), where

TTC(n)=ECD(n)−CPD(n). The first row in the table contains the entries CPD(1), ECD(1)

and TTC(1), where CPD(1) is the starting date for executing the SET, ECD(1) is the agreed

upon completion date for the SET, and TTC(1) is the agreed upon duration for completing the SET. Figure I is an example of such a table.

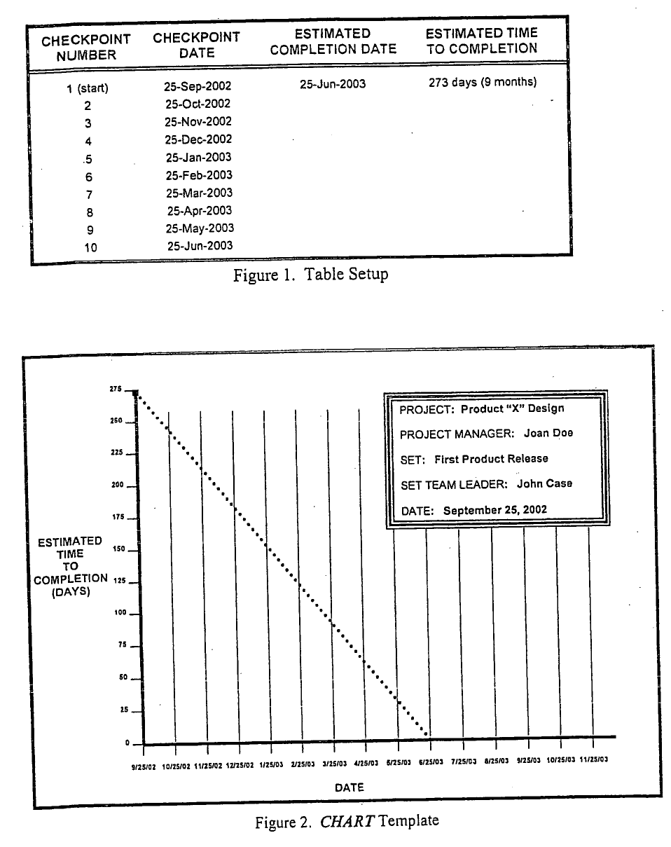

b) Create for each SET a Chart template which contains a two dimensional chart with a horizontal axis labeled DATE (calendar date) and a vertical axis labeled ESTIMATED TIME TO COMPLETION. The vertical axis and horizontal axis intersect at the bottom left corner of the chart, and the left end of the horizontal axis is labeled with the starting date for the SET, i.e. CPD(1). In this example, the scale of the vertical axis is the same as the scale for the horizontal axis, and the horizontal axis extends out at least to ECD(l), the estimated completion date at the beginning of the project. Place a visible mark at TTC(1) on the vertical axis. Add a dotted line to the chart, sloping down at 45 degrees from the foregoing visible mark on the vertical axis and intersecting the horizontal axis at ECD(1). Add information to the template for each SET which identifies the project, task, and/or SET being tracked and the team and/or team leaders charged with completing the SET on the agreed date. FIG. 2 is an example of the appearance of such a CHART template.

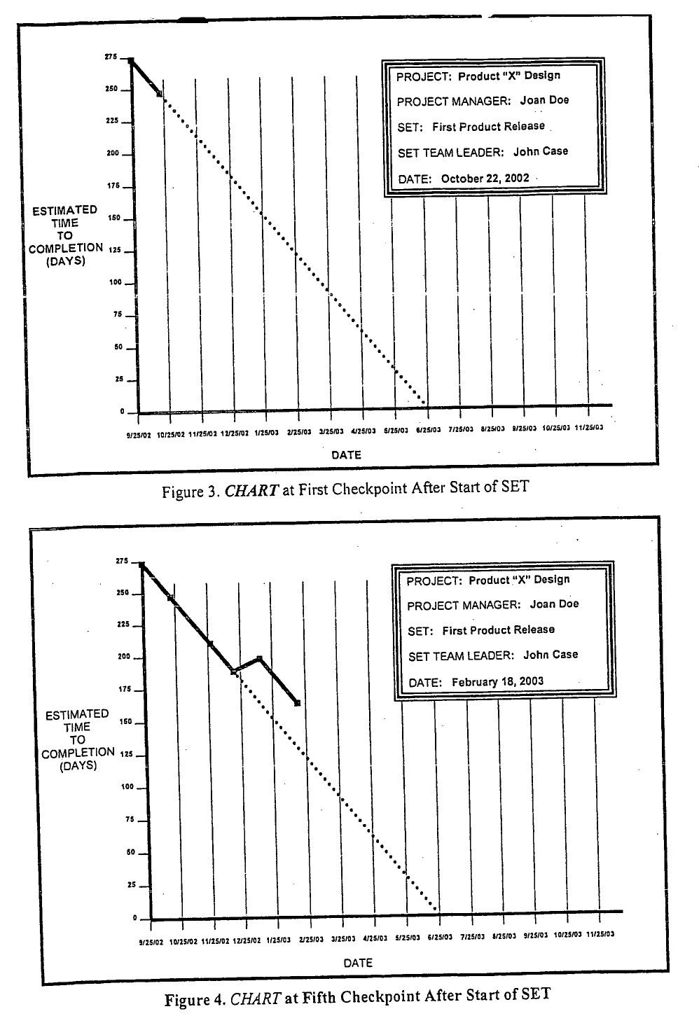

c) At the first checkpoint date for each SET, add an. ordered pair |CPD(2), ECD(2)1 to the table for that SET where CPD(2) is the date of the first checkpoint and ECD(2) is the project team's estimated completion date for the SET as of CPD(2). Add the calculated entity TTC(2) to the table and place a visible mark on the CHART for the SET at distance TTC(2) vertically above the date CPD(2). Create a solid line that connects this visible mark to the previous visible mark. FIG. 3 is an example of the appearance of a CHART as of the first checkpoint after project start.

d) At each subsequent checkpoint for each SET, add another ordered pair JCPD(n), ECD(n) and computed TTC(n) to the table for that SET. Place a visible mark on the CHART for the SET a distance TTC(n) vertically above the date CPD(n), and create a solid line which connects this visible mark to the previous visible mark. FIG. 4 is an example of the appearance of a CHART as of the fifth checkpoint after project start.

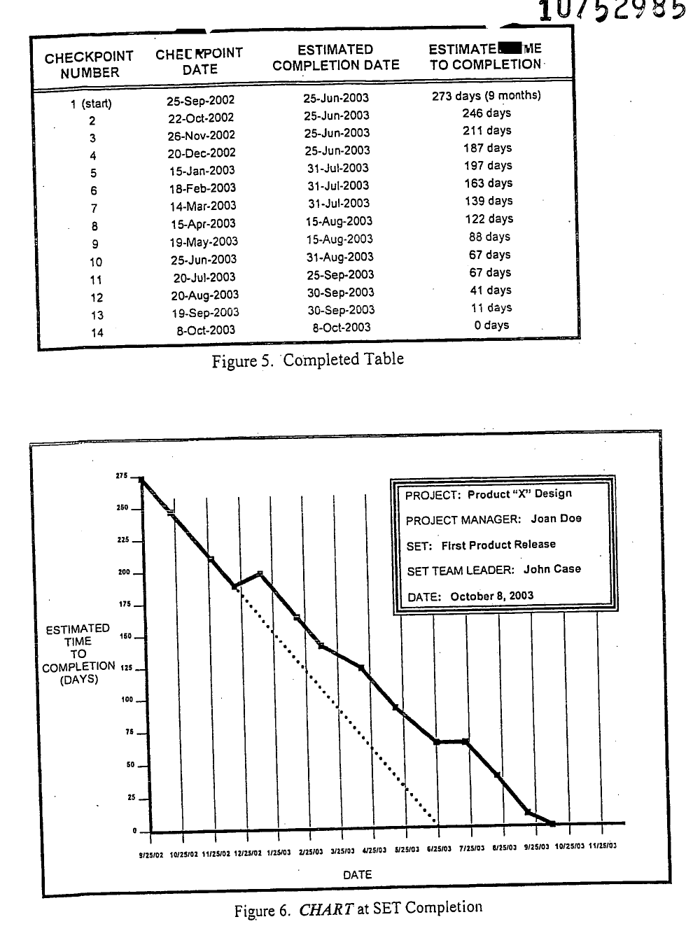

e) When the SET has been successfully completed, add a final ordered pair JCPD(N), ECD(N) and computed TTC(N) to the table for that SET. Place a visible mark on the CHART for the SET on the horizontal axis at the date CPD(N), and create a solid line which connects this visible mark to the previous visible mark. FIG. 5 is an example of a completed table and FIG. 6 is an example of the appearance of a completed CHART.

### 5. Additional Embodiments

The display charts comprising this invention can be generated manually, as described in the preceding specific embodiment. However, the use of automatic mechanisms such as computer programs is equally possible (the steps in the manual embodiment acting as a flow chart for the programming and user input steps). Such computer programs could be a template for commercially-available software such as Microsoft Excele® (with or without the use of MACROS), or could be custom software written in any standard or non-standard computer language.

6. Additional Situations Where a CHART Might Be Used

In the Item 4 example above—“One Specific Embodiment (Example—Manual Method)”,it is surmised that project leaders decide to use the CHART method of this invention in advance of the beginning of the project. This is a typical case where the success of the project is judged to depend upon its completion on or before the expected end date.

However, it also can be useful to initiate the use of a CHART in the midst of (or even after the completion of) a project.

For example, a project manager or project management team may conclude during the execution of a project that emphasis upon schedule should be increased. This conclusion (or the perception that completion of the project by the expected end date is in jeopardy) could result in introducing the use of a CHART after a project has begun.

A project manager or management team might decide after a project has been completed that a post-project review of schedule history is useful, particularly if business repercussions arose because the project did not meet its schedule objectives. If sufficient historical information on estimated completion dates is available to facilitate creating a CHART for the project, then the resulting display of schedule performance could provide a useful tool for retroactively evaluating performance of the project team, thereby guiding future business decisions on similar projects.

7. Adaptations of the CHART to Accommodate Project Changes

Projects often encounter situations which call for a change in scope. This section describes a manual embodiment for three such chances, a), b) and c) for which adaptations of the CHART are easily accommodated. In a similar way, this invention covers other types of project changes are likely to be accommodated in a useful way into the design of a CHART.

a) Reduction in Scope—Split-off of Task(s) From the SET
One common method of recovering from impending project schedule slippages is to drop
one or more tasks from a SET, thereby allowing the reduced-scope SET to be completed
at an earlier date. The tasks which are dropped may then be re-scheduled for completion
at a later date.

The CHART can be modified to show this situation as follows:
For each new SUB-SET (i.e. groups of split-off tasks which have the same re-scheduled expected completion date), create four new columns in the table described in 4 a). The four new columns will hold checkpoint number “m”, ordered pairs {CPD(i,m), ECD(i,m)} where “CPD(i,m)” is the mth checkpoint date for the ith SUB-SET, and “ECD(i,m)” is the estimated completion date for the ith SUB-SET as of the mth checkpoint date. The fourth added column contains a calculated entity—Time To Completion for the ith SUB-SET, TTC(i,m), where TTC(i,m)=ECD(i,m)-CPD (i,m).
Place a visible mark on the CHART for the SET at distance TTC(i,1) vertically above the date CPD(i,1). Add a dotted line to the CHART, sloping down at 45 degrees from the foregoing visible mark and intersecting the horizontal axis at ECD(i, 1). It is preferable to use visible marks and dotted lines that are distinguishable (e.g. by color, weight and/or style) from other such entities on the same CHART, and to label the SUB-SET at the first visible mark for that SUB-SET.
At subsequent checkpoints (which may or may not coincide with checkpoints for the original SET), add new visible marks for the SUB-SET and connect a solid line from this visible mark to all previous visible marks for that SUB-SET. It is preferable to use a solid line which, in a similar fashion to the visible marks and otted line, is distinguishable (e.g. by color, weight and/or style) from other such solid lines on the same CHART.

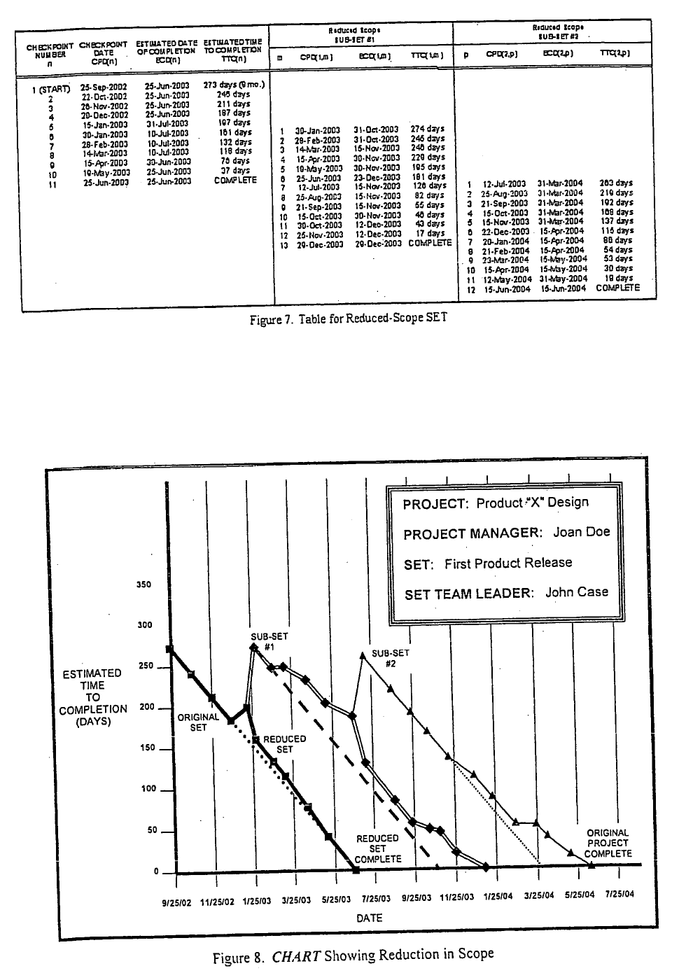

FIG. 7 and FIG. 8 show an example of the appearance of a Table and CHART after two-SUB-SETS have been split off from the primary SET. They illustrate that, while the project team was able to complete the reduced SET on schedule, they were unable to complete the original SET of tasks without dramatic delays.

b) Expansion in Scope—Adding New Task(s) to the SET

It is not uncommon to conclude, after work on a SET has begun, that the overall SET will be more valuable if one or more new tasks are added which must be completed at the same time as the original SET. The addition of such tasks may result in a longer time needed to complete work on the expanded SET, but this constitutes a legitimate change in schedule.

The CHART can be modified to show this situation as follows:

For the expanded SET (i.e. expanded group of tasks which have the same rescheduled expected completion date), create four new columns in the table described in 4 a). The four new columns will hold checkpoint number “m”, ordered pairs | CPD(i,m), ECD(i,m) 1, and TTC(I,m), where “CPD(i,m)” is the mth checkpoint date for the ith expanded SET, “ECD(i,m)” is the estimated completion date for the ith expanded SET as of the mth checkpoint date, and TTC(i,m)=ECD(i,m)−CPD(i,m).
Place a visible mark on the CHART for the expanded SET at a distance TTC(i,1) vertically above the date CPD(i,1). Add a dotted line to the CHART, sloping down at 45 degrees from the foregoing visible mark until it intersects the horizontal axis at ECD(i,I), and sloping up at 45 degrees until it intersects the vertical axis of the CHART. It is preferable to use the same color, weight and style for the visible marks and dotted line as the original elements on the same CHART, and to change the color, weight and/or style of the original dotted line to something which is easily distinguishable from the original. The new SET should be labeled at its first visible mark with text which clearly identifies the expanded SET.
At subsequent checkpoints, entries are made only to the new columns and entries into the original columns are suspended. Add new visible marks for the expanded SET and connect a solid line from this visible mark to all previous visible marks for that expanded SET. It is preferable to use a solid line which matches in color, weight and style the original lines in the same CHART.

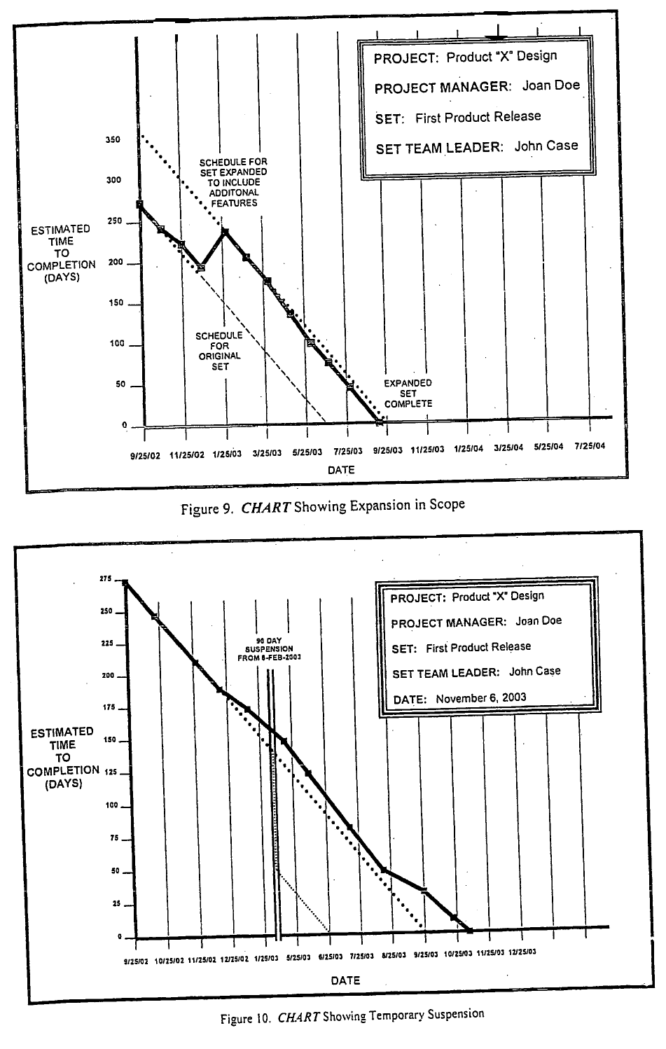

FIG. 9 is an example of the appearance of a CHART after the scope of a SET has been expanded with new tasks and a corresponding re-scheduled completion date. It illustrates that, while the original SET had been anticipated at an earlier date, the later completion date is a result of more work rather than poor performance from the project team.

c) Change in Scope—Suspending Execution of the SET

It is possible, after work on a SET has begun, that other priorities may cause a temporary suspension of work on that SET. Such a suspension naturally changes the expected completion date of the SET.

The CHART can be modified to show this situation as follows:

When the temporarily-suspended SET is resumed, create four new columns in the table described in 4 a). The four new columns will hold entries for checkpoint number “m”, CPD(i,m), ECD(i,m) and TTC(i,m). “CPD(i,m)” is the mth checkpoint date, “ECD(i,m)” is the estimated completion date for the ith resumed SET as of the mth checkpoint date, and TTC(i,m)=ECD(i,m)-CPD(i,m) is the calculated time-to-completion for the resumed SET.
Re-structure the labeling on the horizontal (DATE) axis of the CHART such that the date of suspension and the date of resumption occupy the same point on the axis-i.e. “cut” the time of suspension from the DATE axis. Construct a double vertical line at this point on the axis and label the line with information concerning the suspension.
Place a visible mark on the CHART for the resumed SET at a distance TTC(i,1) vertically above the date CPD(i,1), and connect a solid line from this visible mark to the last visible mark of the original SET. It is preferable to use the same color, weight and style for the visible mark and solid line as the original elements on the same CHART.
At subsequent checkpoints, add new visible marks for the resumed SET and connect a solid line from this visible mark to all previous visible marks for that resumed SET. It is preferable to use a solid line which matches in color, weight and style the original lines in the same CHART.

FIG. 10 is an example of the appearance of a CHART after a SET has been suspended and then resumed. It illustrates that, while the original SET had been anticipated at an earlier date, the later completion date is a result of a suspension in work rather than poor performance from the project team.

Style Variations

While this disclosure has from time to time referred to dotted lines with solid line additions, the use of color may be used to achieve the same purpose. For example, a line in a color green could be used as the dotted line, a black line provided as the solid line, positive deviations provided in a color green, and negative deviations in a color red.

These and other objects and features of the invention are now described in terms of preferred embodiments. It will be appreciated, however, that novel and useful printed matter, apparatus, and method for customizing a schedule display are disclosed. While the invention is particularly shown and described with reference to preferTed embodiments of varying scope, it will be understood that various changes in form and detail may be made without departing from the spirit and scope of the invention.

1. A user scheduling apparatus for project management, comprising:
a database that stores a project schedule, the project schedule containing at least one project task;
an input device that receives user input data, said user input data related at least to a time to complete status of the at least one project task;
an estimator that determines an estimated time of completion of the at least one project task;
a project schedule modifier that generates an estimated time of completion schedule;
a display apparatus that displays the project schedule and the estimated time of completion schedule simultaneously.

2. The scheduling apparatus of claim 1, wherein the estimated time of completion schedule and the project schedule are combined into a revised project schedule.

3. The scheduling apparatus of claim 1, wherein the estimator is at least one of a suspended time estimator and a change of scope estimator.

4. A computer program that customizes a project schedule, comprising the steps of:
retrieving from a database a project schedule, the project schedule containing at least one project task;
receiving from an input device user input data, said user input data related at least to a time to complete status of the at least one project task;
determining an estimated time of completion of the at least one project task based on the user input updates;
generating an estimated time of completion schedule based on the project schedule and the estimated time of completion; and
displaying on a display apparatus the project schedule and the estimated time of completion schedule simultaneously.

5. The computer program of claim 4, further comprising the step of combining the estimated time of completion schedule and the project schedule into a revised project schedule.

6. The computer program of claim 4, wherein the estimated time of completion is determined by at least one of a suspended time estimator and a change of scope estimator.

7. A project scheduling method for scheduling a project, comprising the steps of:
retrieving from a database a project schedule, the project schedule containing at least one project task;
receiving from an input device user input data, said user input data related at least to a time to complete status of the at least one project task;
determining an estimated time of completion of the at least one project task based on the user input updates;
generating an estimated time of completion schedule based on the project schedule and the estimated time of completion; and
displaying on a display apparatus the project schedule and the estimated time of completion schedule simultaneously.

8. The project scheduling method of claim 7, further comprising the step of combining the estimated time of completion schedule and the project schedule into a revised project schedule.

9. The project scheduling method of claim 7, wherein the estimated time of completion is determined by at least one of a suspended time estimator and a change of scope estimator.
